(19) United States
(12) Patent Application Publication
(10) Pub. No.: US 2023/0238652 A1
(43) Pub. Date: Jul. 27, 2023

(54) SECONDARY BATTERY WITH IMPROVED BATTERY SEPARATOR

(71) Applicant: Celgard, LLC, Charlotte, NC (US)

(72) Inventor: Hiroyuki Suzuki, Tokyo (JP)

(21) Appl. No.: 18/015,423

(22) PCT Filed: Jul. 10, 2021
(86) PCT No.: PCT/US2021/041193

§ 371 Date: Jan. 10, 2023

Related U.S. Application Data
(60) Provisional application No. 63/051,742, filed on Jul. 14, 2020.

(51) Int. Cl. H01M 50/451; H01M 50/403; H01M 4/58; H01M 4/525; H01M 4/505; H01M 50/414; H01M 50/431

(52) U.S. Cl. CPC H01M 50/451; H01M 50/403; H01M 4/58; H01M 4/525; H01M 4/505; H01M 50/414; H01M 50/431

(57) ABSTRACT

A secondary battery that generates or includes metal-ion contaminants selected from copper ions, manganese ions, nickel ions, cobalt ions, iron ions, aluminum ions, chrome ions, molybdenum ions, tin ions or combinations thereof, the battery comprising: an anode; a cathode; a coated or uncoated battery separator between the anode and the cathode, wherein the coated or uncoated battery separator comprises a trap layer; and an electrolyte. The battery improve yield rate of initial charge and aging process and exhibits prolonged useful life due to the separator, which reduces or eliminates metal-ion contamination in the battery.

### CROSS REFERENCE TO RELATED APPLICATIONS

This application is a 371 U.S. Application claiming priority to PCT/US2021/041193, filed Jul. 10, 2021, which claims priority to U.S. Provisional Patent Application Ser. No. 63/051,742, filed Jul. 15, 2020, which is hereby fully incorporated by reference herein.

### FIELD

This application is directed to a secondary battery with an improved battery separator, particularly a battery separator that may be reduce or eliminate metal-ion contamination in a secondary battery, particularly a secondary battery susceptible to metal-ion contamination.

### BACKGROUND

Commonly used electrode materials for a secondary battery may contain transition metals including iron (Fe), manganese (Mn), nickel (Ni), cobalt (Co), aluminum (Al), chrome (Cr), molybdenum (Mo), tin (Sn), and others. For example, some exemplary electrode materials may include Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof. Some of these electrode materials interact with the electrolyte resulting in the presence of transition metal ions in the electrolyte. Under the right conditions, these metal ions maybe reduced to their metal form. This metal plating will result in, among other things, dendrite growth. When dendrites grow through the separator, connecting both electrodes, a short results. Poisoning of a graphite electrode may also result, for example, from plating of transition metal ions on the electrode. This may reduce the useful life of the battery.

Another source of metal contamination may be metallic equipment, e.g., brushes, rollers, etc. used to manufacture battery parts and/or batteries. Metallic equipment may be a source of cobalt, copper, zinc, chrome, or iron ions in the battery.

FIG. 12 shows two issues resulting from metal contamination in a battery-internal short circuit self-discharge and deactivation of the anode material which is a factor in capacity degradation.

In view of the foregoing, methods to reduce, eliminate, or mitigate metal contamination in a battery may be desirable.

### SUMMARY

In one aspect, a secondary battery that generates or comprises metal ion contaminants selected from, but not limited to, copper ions, manganese ions, nickel ions, cobalt ions, iron ions, chrome ions, molybdenum ions, tin ions, or combinations thereof is described. Metal ion contaminants may be generated from the battery's electrode material. For example, the battery's cathode material may comprise Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof. Alternatively or additionally, presence of metal ion contaminants may be due to metallic equipment, e.g., brushes, rollers, etc., used in the battery manufacture process. The secondary battery described herein may have reduced or eliminated metal contamination issues, due to the use of a separator as described herein, compared to batteries where the separator is not used.

The secondary battery described herein may comprise the following components: an anode, a cathode, a coated or uncoated battery separator comprising a trap layer between the anode and the cathode, and an electrolyte. The battery separator may comprise a trap layer that is part of the separator. For example, the trap layer may be in the middle of the battery separator or on a side of the battery separator that is closest to the anode. Alternatively or in addition to a trap layer being part of the battery separator, a trap layer may be provided as a coating or as one layer of a coating on a side of the battery separator that faces the anode.

With regard to embodiments where the trap layer is part of the separator, the potential difference of the trap layer vs. Li+/Li is in the range from +0.0V to +5.0V, from +0.0V to +4.0V, from +0.0V to +3.5V, from +0.0V to +3.0V, from +0.0V to +2.5V, from +0.0V to +2.0V, from +0.0V to +1.5V, or from +0.0V to 1.0V.

In embodiments where the trap layer is part of the separator, the trap layer may have a bulk or volume resistivity of 10⁴ to 10⁹ ohms-cm, 10⁵ to 10⁹ ohms-cm, 10⁶ to 10⁹ ohms-cm, 10⁷ to 10⁹ ohms-cm, or 10⁸ to 10⁹ ohms-cm. In some preferred embodiments, the bulk or volume resistivity may be from 10⁴ to 10⁹ ohms-cm, 10⁴ to 10⁸ ohms-cm or from 10⁴ to 10⁷ ohms-cm. Particularly preferred resistivity may be 10⁴ to 10⁸ ohms-cm or from 10⁴ to 10⁷ ohms-cm.

In some embodiments, the trap layer may be incorporate as part of the separator through a lamination process, a co-extrusion process, or a combination of a lamination and a co-extrusion process.

With regard to embodiments where the trap layer is part of the separator, the trap layer may comprise carbon and a polymer. The carbon may be a conductive carbon in some embodiments. The carbon may be selected from carbon black, acetylene black, carbon nanotubes, graphene, or combinations thereof. In some other embodiments where the trap layer is part of the separator, the trap layer may comprise a conductive polymer. For example, the conductive polymer may be a poly-acetylene, a poly-thiophene, a poly-aniline, a poly-pyrrole, or combinations thereof.

With regard to embodiments where the trap layer is provided as a coating or as one layer of a coating, the potential difference of the trap layer vs. Li+/Li is in the range from +0.0V to +5.0V, from +0.0V to +4.0V, from +0.0V to +3.5V, from +0.0V to +3.0V, from +0.0V to +2.5V, from +0.0V to +2.0V, from +0.0V to +1.5V, or from +0.0V to 1.0V.

In embodiments where the trap layer is provided as a coating or as one layer of a coating, the trap layer may have a bulk or volume resistivity of 10⁴ to 10⁹ ohms-cm, 10⁴ to 10⁸ ohms-cm, or 10⁴ to 10⁷ ohms-cm.

With regard to embodiments where the trap layer is provided as a coating or as one layer of a coating, the trap layer may comprise carbon and a polymer. The carbon may be a conductive carbon in some embodiments. The carbon may be selected from carbon black, acetylene black, carbon nanotubes, graphene, or combinations thereof. In some other embodiments where the trap layer is provided as a coating or as one layer of a coating, the trap layer may comprise a conductive polymer. For example, the conductive polymer may be a poly-acetylene, a poly-thiophene, a poly-aniline, a poly-pyrrole, or combinations thereof.

### DESCRIPTION OF THE FIGURES

FIG. 1 depicts secondary batteries according to some embodiments herein.

FIG. 2 depicts secondary batteries according to some embodiments herein.

FIG. 3 depicts secondary batteries according to some embodiments herein.

FIG. 4 depicts secondary batteries according to some embodiments herein.

FIG. 5 depicts secondary batteries according to some embodiments herein.

FIG. 6 depicts secondary batteries according to some embodiments herein.

FIG. 7 depicts secondary batteries according to some embodiments herein.

FIG. 8 depicts secondary batteries according to some embodiments herein.

FIG. 9 depicts secondary batteries according to some embodiments herein.

FIG. 10 depicts secondary batteries according to some embodiments herein.

FIG. 11 depicts secondary batteries according to some embodiments herein.

FIG. 12 is a schematic drawing depicting two issues resulting from metal contamination in a secondary battery.

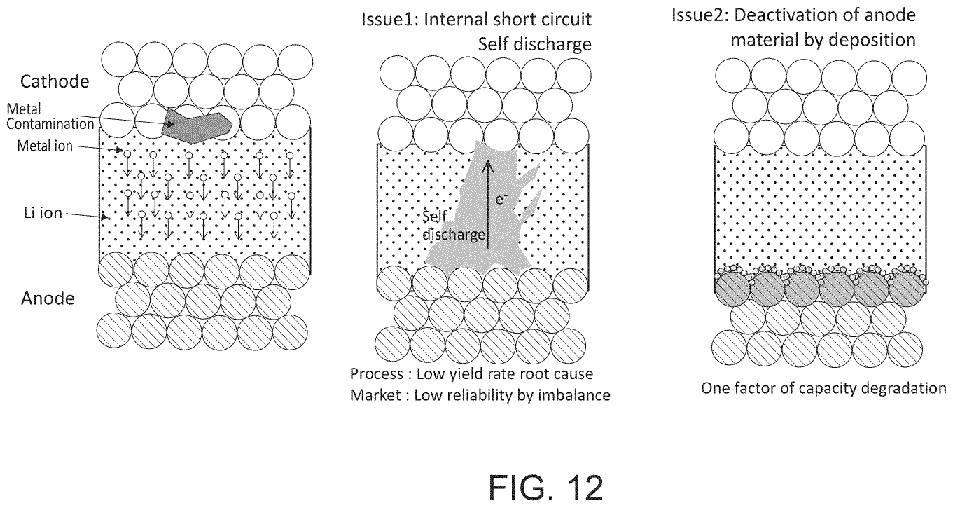

FIG. 13 is a schematic drawing depicting one solution to prevent, reduce, or mitigate the issues that result from metal contamination in a secondary battery.

FIG. 14 is a schematic drawing of comparative and inventive embodiments described herein, and includes calculations showing that inventive embodiments exhibit more than 1,000 times lower self-discharge than comparative embodiments.

FIG. 15 is an SEM image of a battery separator according to some embodiments described herein.

FIG. 16 is a schematic drawing of a battery cell according to some embodiments described herein.

FIG. 17 includes graphs showing voltage over time for inventive and comparative embodiments described herein.

FIG. 18 is an SEM image showing metal deposition on inventive and comparative embodiments described herein.

FIG. 19 includes SEM images of a metal trap layer according to some embodiments described herein before and after metal trapping.

### DETAILED DESCRIPTION

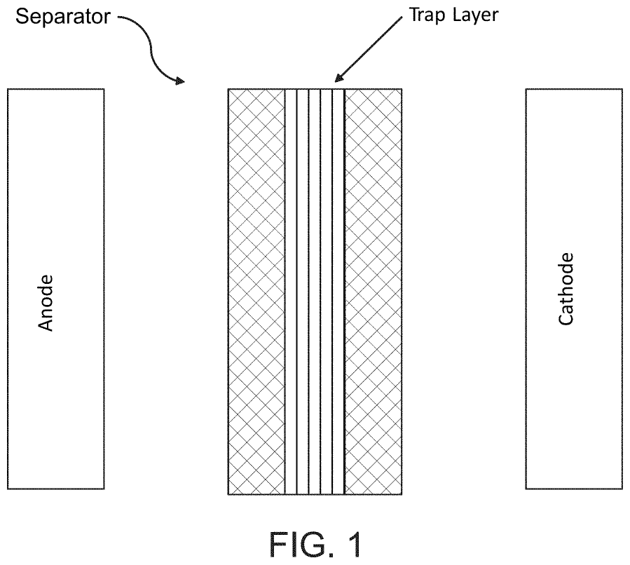

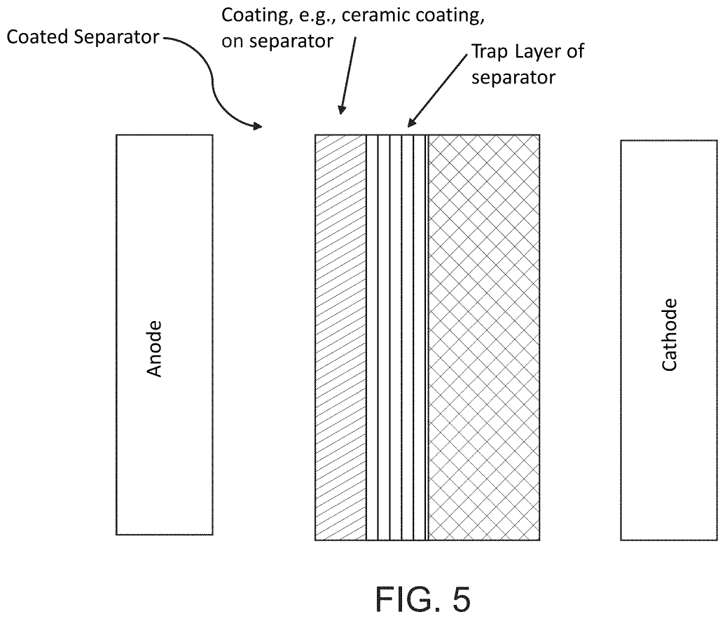

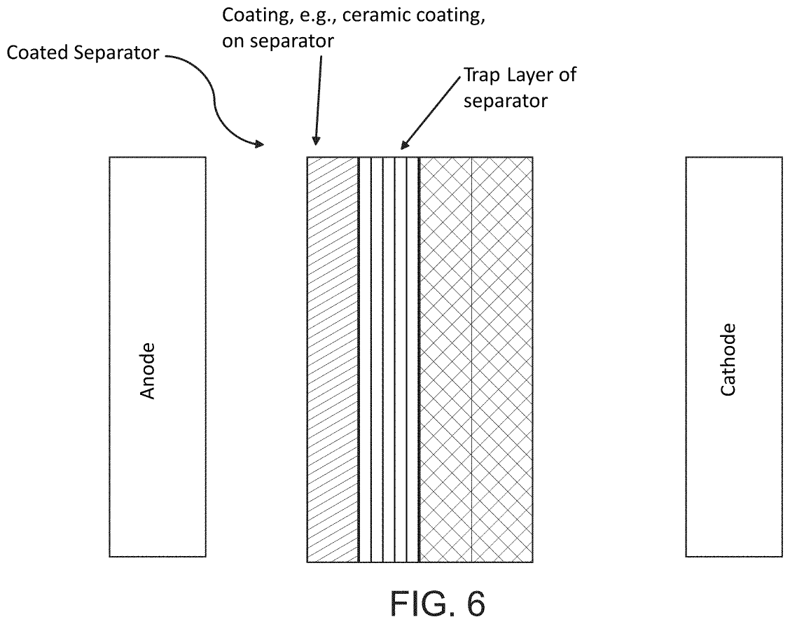

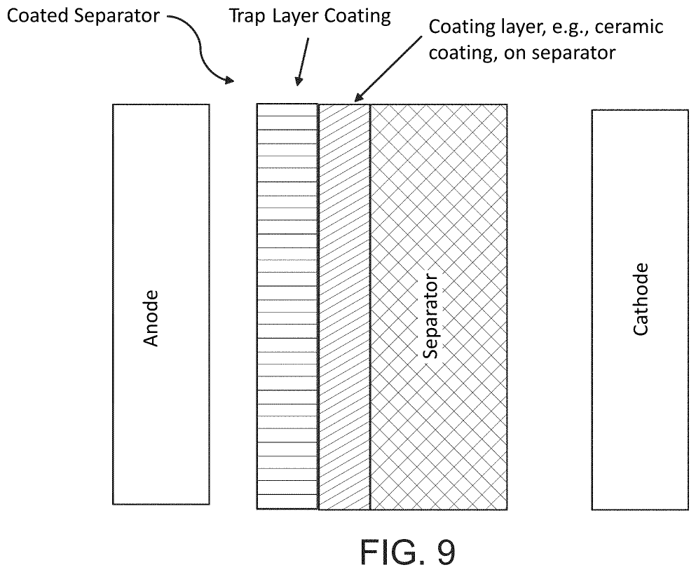

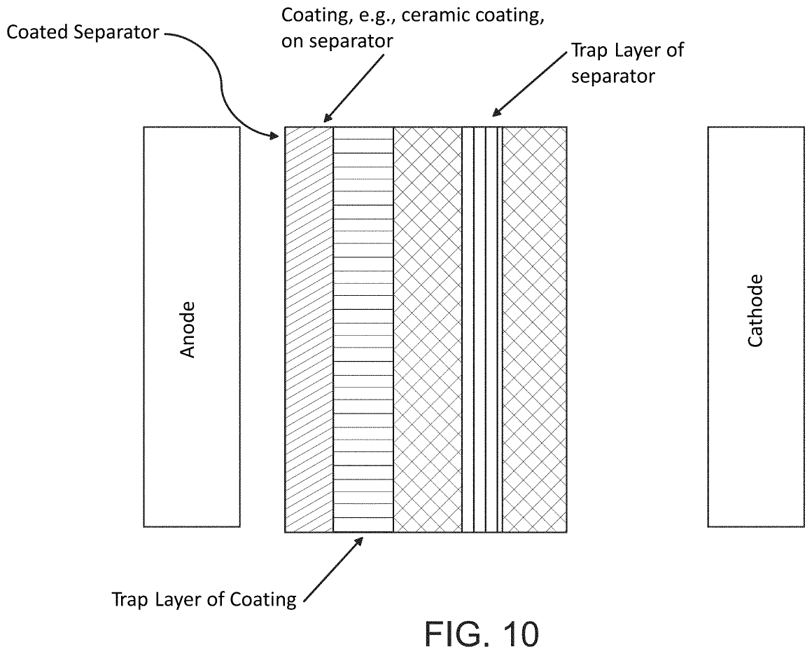

Disclosed herein is a secondary battery that has or is susceptible to metal contamination and has improved useful life due at least in part to the separator utilized therein. The battery may comprise, consist of, or consist essentially of, an anode, a cathode, a separator between the anode and the cathode, and an electrolyte. The separator may be a coated separator or an uncoated separator, and a trap layer may be part of the separator, part of the coating, or both part of the separator and part of the coating. Where the trap layer is part of the separator, it is preferably in the middle of the separator or on a side of the separator closest to the anode. When the trap layer is part of a coating (trap layer coating), it is part of a coating on an anode-facing side of the separator. Examples of secondary batteries according to some embodiments described herein are shown in FIGS. 1-11 and elsewhere.

Cathode

The cathode of the secondary battery described herein is not so limited, but may preferably be a cathode-material that generates metal ion contamination in the battery. For example, the cathode material may transition-metal-containing compounds that can be used for the cathode. In some embodiments, the cathode material may be selected from Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof.

Anode

The Anode material of the secondary battery described herein is not so limited, and may be any anode-material for use in a secondary battery. In some preferred embodiments, the anode material may be one susceptible to metal-ion contamination in the cell such as graphite.

Electrolyte

The electrolyte material of the secondary battery described herein is not so limited, and any electrolyte suitable for use in a secondary battery may be used. In some preferred embodiments, the electrolyte is a liquid electrolyte.

Separator

The separator herein may be one of the following: an uncoated separator comprising a trap layer, a coated separator where the coating comprises a trap layer, a coated separator where the separator comprises a trap layer, or a coated separator where the coating and the separator comprise a trap layer

Uncoated Separator Comprising a Trap Layer

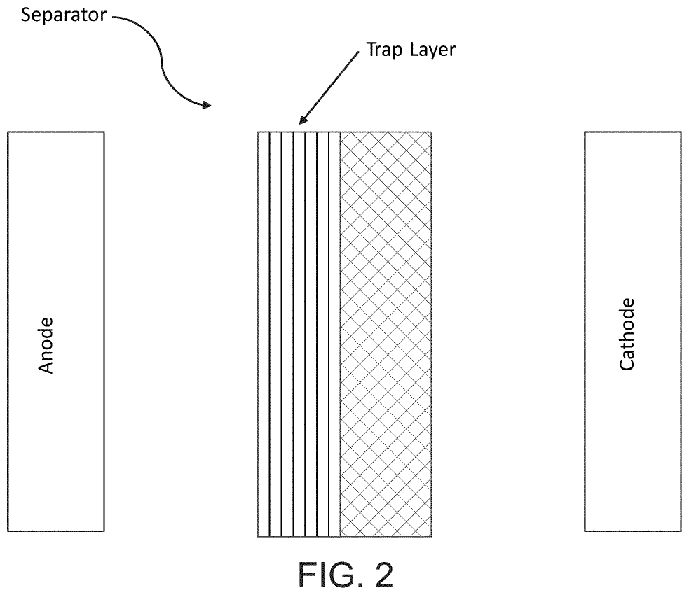

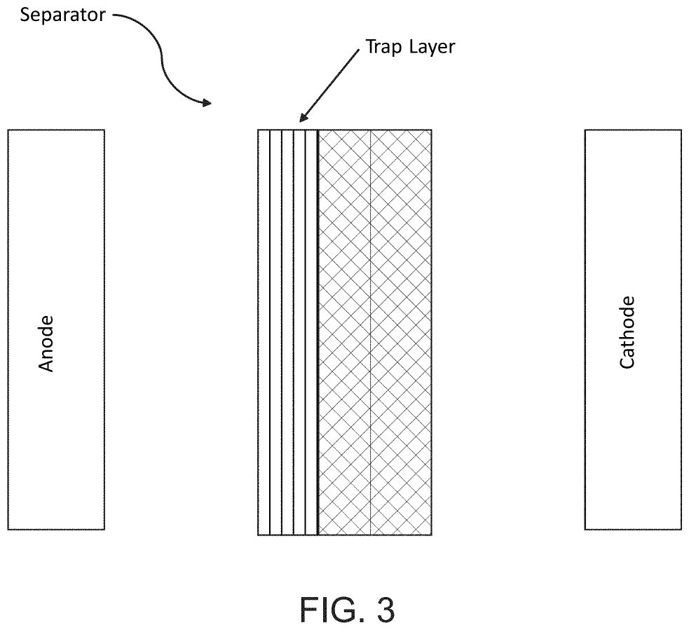

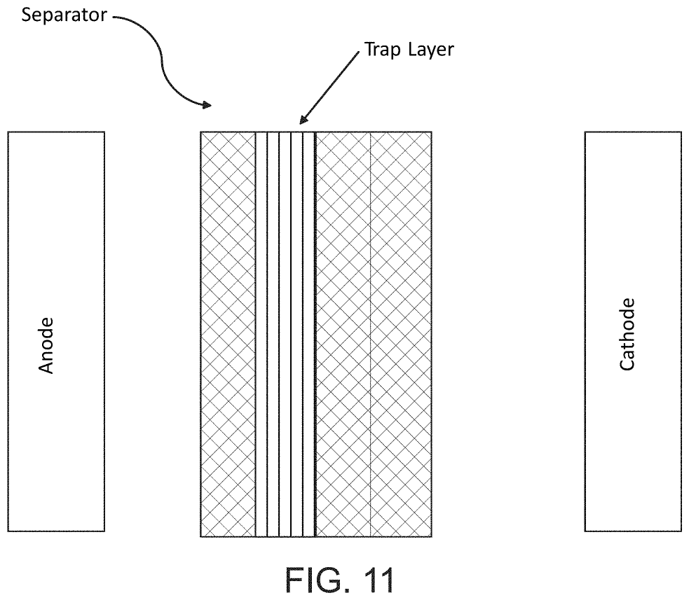

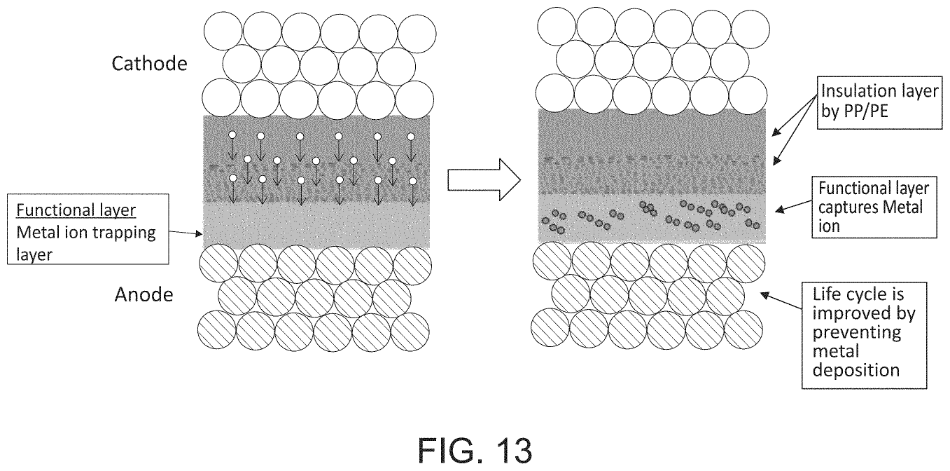

The uncoated separator Comprising a Trap Layer may be a porous membrane with one or more trap layers therein. The one or more trap layers may be external layers, see FIG. 2, FIG. 3, and FIG. 13 internal layers, see FIG. 1 and FIG. 11, or if two or more trap layers are present, both internal and external layers. The trap layer may be incorporated into the separator by any means, including but not limited to co-extrusion, lamination, or both. For example, the trap layer material and a polyolefin-containing material may be co-extruded and then stretched to form pores in order to form a two-layer uncoated separator as shown in FIG. 1. Alternatively, the trap layer material and polyolefin-containing material may be separately extruded to form two separate nonporous precursors. These precursors may be laminated together before or after stretching to form a two-layer uncoated separator as shown in FIG. 1. The polyolefin-containing material may comprise, consist of, or consist essentially of polypropylene, polyethylene, or copolymer, terpolymers, or blends, thereof.

The uncoated separator with a trap layer may, in preferred embodiments, be a microporous membrane.

The uncoated separator with a trap layer may be formed by any method, but in preferred embodiments, the uncoated separator with a trap layer may be formed by a dry-stretch method such as the Celgard dry-stretch method. A dry-stretch method may comprise, consist of, or consist essentially of an extrusion (or co-extrusion) step, an annealing step, and a stretching (uniaxially or biaxially) step. A dry-stretch method does not utilize solvents or oils, or uses only minimal amounts. The uncoated separator with a trap layer may also be formed by a wet process that does utilize solvents and/or oils. For example, solvents and/or oils may be used for pore formation in a wet process.

Coated Separator with Trap Layer

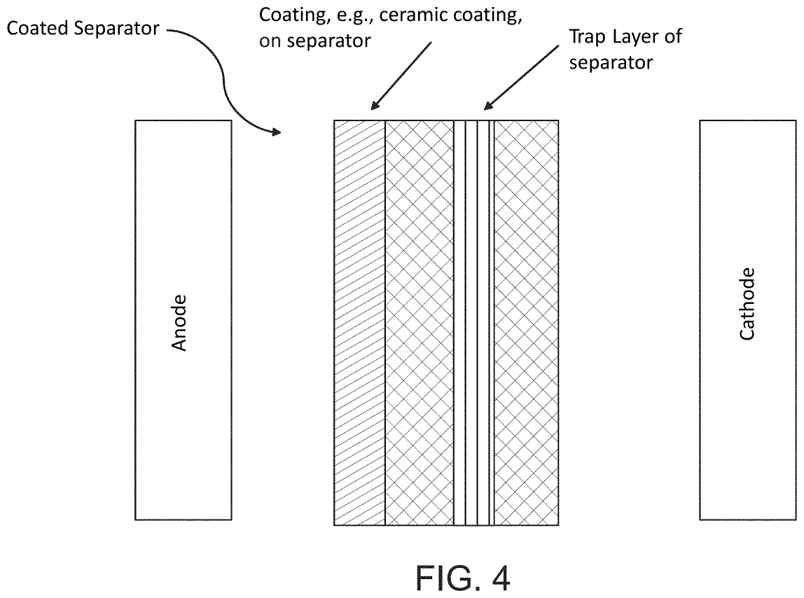

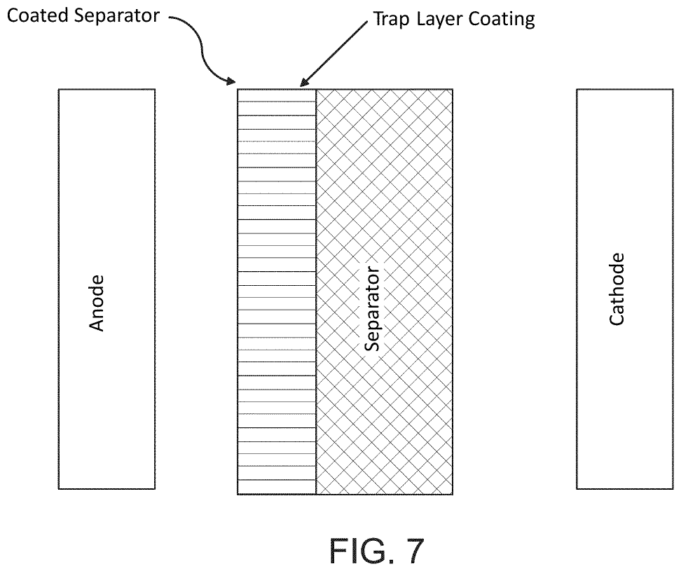

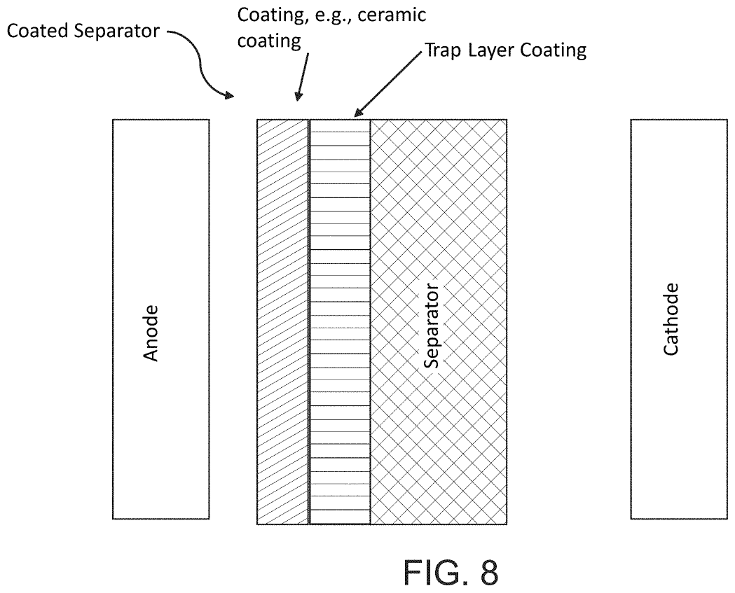

The coated separator may comprise the following: a separator with a trap layer as described hereinabove (see also FIGS. 4-6 and 10) or a separator without a trap layer (see FIGS. 7-9); and a coating on at least one side of the separator. The coating may comprise, consist of, or consist essentially of a trap layer (see FIGS. 7-10). In some embodiments, the coating may comprise two or more layers where the trap layer is one of those layers (see FIGS. 8-10). The other layers of a two or more layer coating may be a ceramic coating layer, a polymer coating layer, a shutdown coating layer, or combinations thereof. In preferred embodiments, the coating comprising the trap layer is on an anode-facing side of separator.

The separator without a trap layer is not so limited and may be any porous or microporous membrane suitable for use as a battery separator. In some preferred embodiments, the separator without a trap layer may comprise, consist of, or consist essentially of one or more polyolefins, including polypropylene, polyethylene, copolymers thereof, or mixtures thereof. The separator without a trap layer may be a monolayer membrane, a bilayer membrane, a trilayer membrane, or a multilayer membrane. The separator without a trap layer may be formed by any method, but in preferred embodiments, the separator without a trap layer may be formed by a dry-stretch method such as the Celgard dry-stretch method. A dry-stretch method may comprise, consist of, or consist essentially of an extrusion (or co-extrusion) step, an annealing step, and a stretching (uniaxially or biaxially) step. A dry-stretch method does not utilize solvents or oils, or uses only minimal amounts. The separator without a trap layer may also be formed by a wet process that does utilize solvents and/or oils. For example, solvents and/or oils may be used for pore formation in a wet process.

Trap Layer

The trap layer, whether part of the separator, part of the coating, or both part of the separator and part of the coating, may have a potential difference vs. Li+/Li that is in the range of +0.0V to +5.0V, +0.0V to +4.5V, from +0.0V to +4.0V, from +0.0V to +3.5V, from +0.0V to +3.0V, from +0.0V to +2.5V, from +0.0V to +2.0V, from +0.0V to +1.5V, or from or from +0.0V to 1.0V. For example, for the trap layer to be able to trap copper ions, the potential difference would have to be +3.38. Li+/Li is at −3.04V relative to H2/2H+, Cu²⁺/Cu is at +0.34V, so the trap layer would have to be at a potential difference of at least +3.38 V relative to Li+/Li to trap the copper ions.

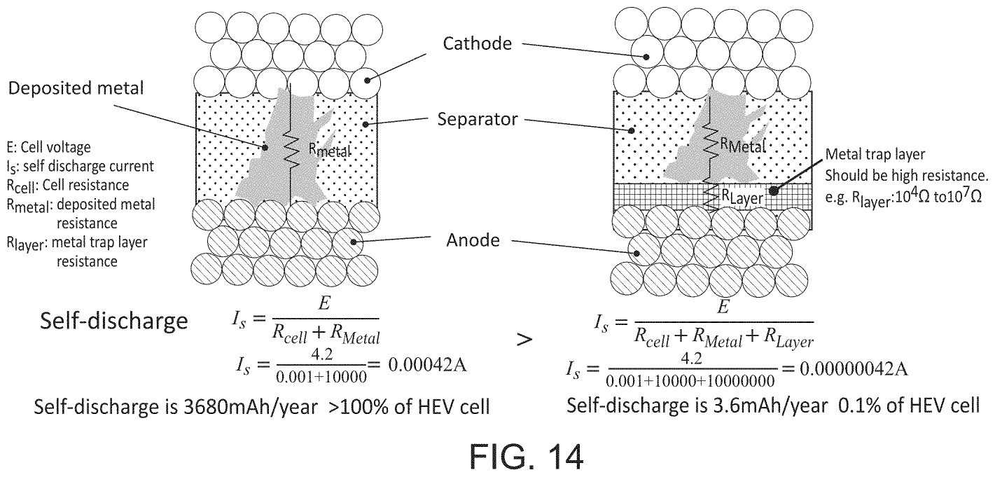

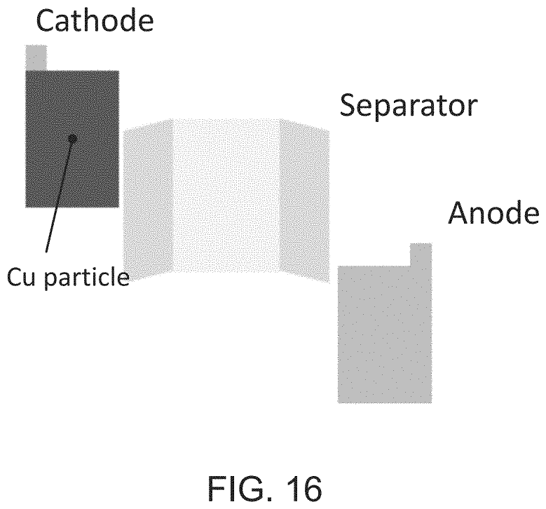

The trap layer, whether part of the separator, part of the coating, or both part of the separator and part of the coating, has a bulk or volume resistivity of 10 to 10⁹ ohms-cm, 10 to 10⁸ ohms-cm, 10 to 10⁷ ohms-cm, 10 to 10⁶ ohms-cm, 10 to 10⁵ ohms-cm, 10 to 10⁴ ohms-cm, 10 to 10³ ohms-cm, or 10 to 10² ohms-cm. In some preferred embodiments, a resistivity from 10⁴ to 10⁹ ohms-cm, 10⁴ to 10⁸ ohms-cm, or 10⁴ to 10⁷ ohms-cm may be preferred. As shown in FIG. 14, using a trap layer with a bulk or volume resistivity within this preferred range results in a self-discharge current that is 1,000 times lower than embodiments where no trap layer is used. When a bulk or volume resistivity falls below 10⁴ ohms-cm, higher self-discharge current will be observed, and when a bulk or volume resistivity is above 10⁷ ohms-cm, the metal trapping function will become lower, resulting in more metal deposition. This can be seen in FIG. 16, which shows higher metal deposition in Example 6, which has a metal trap layer with a bulk or volume resistivity of 10¹⁰ ohms-cm compared to Example 5 where the resistivity is 10⁵ ohms-cm

In some preferred embodiments, the trap layer may comprise, consist of, or consist essentially of carbon and a polymer. In some particularly preferred embodiments, the carbon may be a conductive carbon such as carbon nanotubes. In some embodiments, the carbon is selected from carbon black, acetylene black, carbon nanotubes, graphene, or combinations thereof.

In other preferred embodiments, trap layer may comprise, consist of, or consist essentially of a conductive polymer. The conductive polymer may be selected from a poly-acetylene, a poly-thiophene, a poly-aniline, a poly-pyrrole, or combinations thereof.

### EXAMPLES

Table 1 below shows the reduction potential for certain transition metal ions and gives the minimum potential difference vs. Li+/Li which the trap layer must have to trap each of the listed metal ions. Trapping of the transition metal ions may mean plating of the ions on the trap layer surface.

TABLE 1

| | Minimum Potential difference |
|---|---|
| | vs. Li+/Li which is at −3.04 |
| Transition Metal Reduction | V relative to H2/2H+ for a |
| Potential | functional trap layer |
| Cu²⁺/Cu (+0.34 V) | >+3.38 V |
| Ni²⁺/Ni (−0.26 V) | >+2.78 V |
| Fe²⁺/Fe (−0.45 V) | >+2.59 V |
| Co²⁺/Co (−0.28 V) | >+2.76 V |
| Mn²⁺/Mn (−1.19 V) | >+1.85 V |
| Cr²⁺/Cr (−0.91 V) | >+2.13 V |
| Sn²⁺/Sn(−0.14), | >+2.9 V |
| Mo³⁺/Mo (−0.2 V) | >+2.84 V |

### Example 1

A polypropylene and a trap layer material comprising polypropylene and carbon nanotubes is co-extruded to form a battery separator like that shown in FIG. 1, 2, 3, or 11. The potential difference of the trap layer vs. Li+/Li, which is at −3.04V relative to H2/2H+, is less than +3.39 V after being electrically connected to anode electrode. Conductive trap layer (a bulk or volume resistivity of 10⁴ to 10⁹ ohms-cm, 10⁴ to 10⁸ ohms-cm, or 10⁴ to 10⁷ ohms-cm) is electrically connected by contacting to anode. The conductive trap layer (a bulk or volume resistivity of 10⁴ to 10⁹ ohms-cm, 10⁴ to 10⁸ ohms-cm, or 10⁴ to 10⁷ ohms-cm) is electrically connected to the anode in the following way. The anode contacts to anode faced the trap layer. Metal dendrite grows from anode to internal layer trap layer. Thus, this trap layer can reduce and trap each of the transition metals in Table 1.

### Example 2

A trap layer coating is formed on a polypropylene monolayer battery separator to form a structure like that shown in FIGS. 7 to 9. The coating comprise carbon nanotubes and a polymer binder. The potential difference of the trap layer coating vs. Li+/Li, which is at −3.04V relative to H2/2H+, is less than +3.39 V after being electrically connected to anode electrode. The conductive trap (a bulk or volume resistivity of 10⁴ to 10⁹ ohms-cm, 10⁴ to 10⁸ ohms-cm, or 10⁴ to 10⁷ ohms-cm) is electrically connected to the anode in the following way. The anode contacts to anode faced the trap layer. Metal dendrite grows from anode to internal layer trap layer. Thus, this trap layer can reduce and trap each of the transition metals in Table 1.

### Example 3

Example 3 is like Example 1 except the trap layer material comprises a conductive polymer, not polypropylene and carbon nanotubes.

### Example 4

Example 4 is like Example 2 except the trap layer comprises a conductive polymer, not carbon nanotubes and a polymer binder.

### Examples 5 and 6 and Comparative Example 1

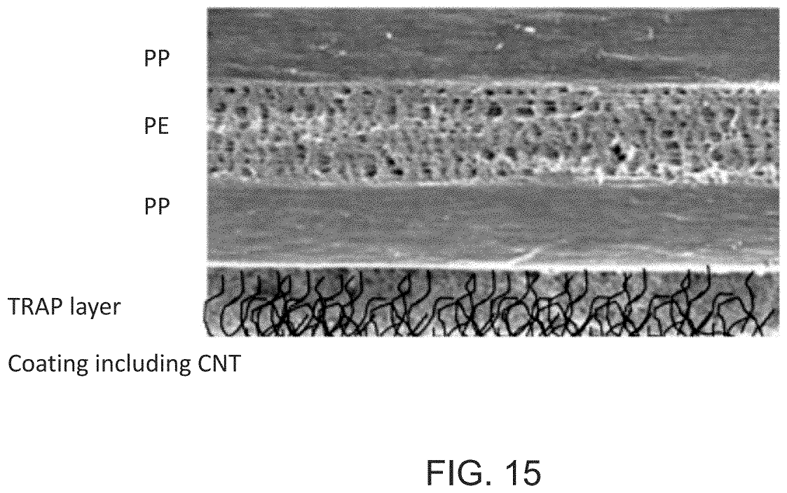

Examples 5 and 6, and Comparative Example 1, were prepared by coating a slurry having a composition as shown in Table 2 onto a surface of a 16 micron polyolefin tri-layer battery separator. The coating in each Example was 4 microns thick. FIG. 15 shows an SEM of a trilayer battery separator coated with a slurry comprising carbon nanotubes (CNT).

TABLE 2

| | | Acrylic | | | |
|---|---|---|---|---|---|
| | Alumina | binder | thickener | CNT | Resistivity |
| | (%) | (%) | (%) | (%) | (Ohm-cm) |
| Example 5 | 93.95 | 5 | 1 | 0.05 | 10⁵ |
| Example 6 | 93.99 | 5 | 1 | 0.01 | 10¹⁰ |
| Comparative | 94.00 | 5 | 1 | 0 | ND |
| Example 1 | | | | | |

Cells were formed using the separators of Examples 5, 6, and 7. The Cell configuration was as follows. The cell structure was a laminated cell (36 mAh). Electrode size was 50 mm×30 mm. The cathode material was NCM111 and the anode material was graphite. The electrolyte was EC/EMC=1/2, 1M LiPF6, VC1 wt %. A 50 um copper particle was placed on cathode electrode to simulate contamination metal. A schematic drawing of this cell is in FIG. 16.

Charging and discharging conditions are as follows. Charge conditions are 4.2V CCCV 1 mA 0.2 mA cut off. Aging was 3 days (checked voltage drop by internal short circuit). Temperature was 25° C.

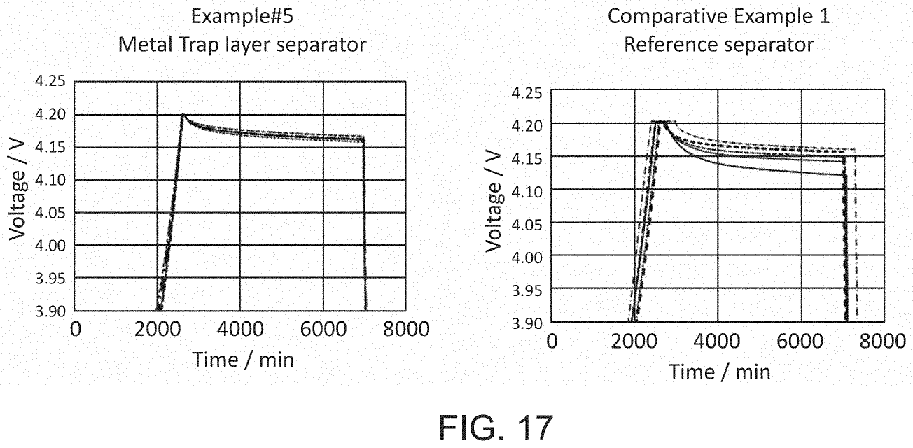

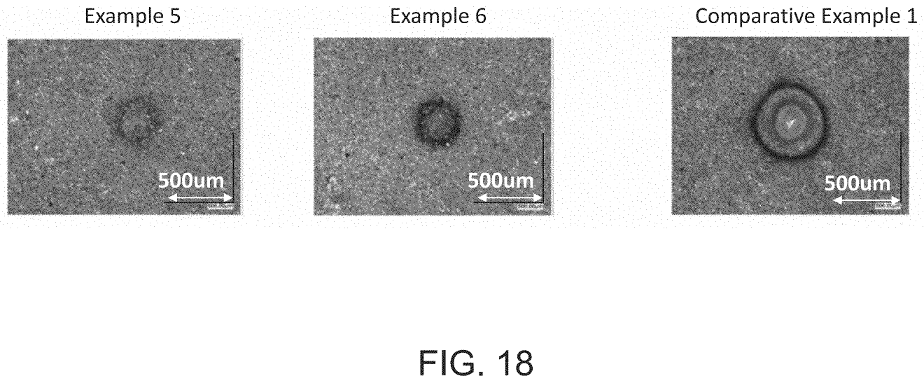

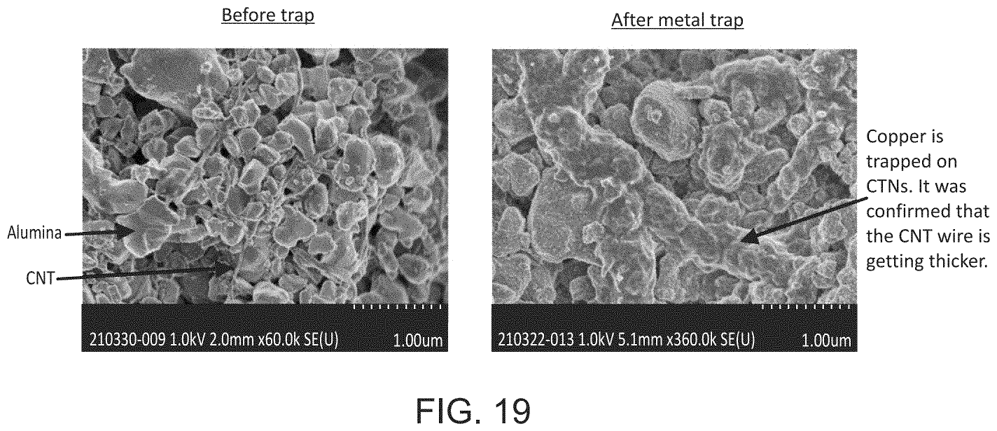

Results are shown in FIGS. 17, 18, and 19. FIG. 17 shows that the comparative separator has a greater voltage drop over time. Thus, it can be seen that the self-discharge level during aging is small due to the effect of the metal trap separator. The effect of the high-resistance metal trap layer increased the short-circuit resistance during internal short-circuit, and the discharge current was confirmed to be small. FIG. 18 shows images of the anode surface taken after deconstructing the cells following a cell aging process. Metal trap separators (Examples 5 and 6) showed a decrease in deposition of copper (metal contamination) on the anode compared to comparative Example 1, which does not use a metal trap separator. This is due to the separator in Examples 5 and 6 trapping the copper. Example 5 with high CNT content (and lower resistance) was more effective than Example 6 with low CNT content (and higher resistance). FIG. 19 shows the CNTs of the metal trap separator trapping copper. In comparing the “before trap” and “after metal trap” images, it can be seen that the CNTs become thicker as copper is deposited on them.

1. A secondary battery that generates or comprises metal-ion contaminants selected from copper ions, manganese ions, nickel ions, cobalt ions, iron ions, chrome or Cr ions, molybdenum ions, tin ions or combinations thereof, the battery comprising:
an anode;
a cathode;
a coated or uncoated battery separator between the anode and the cathode, wherein the coated or uncoated battery separator comprises a trap layer; and
an electrolyte.

2. The battery of claim 1, wherein the battery separator is a coated battery separator with a coating on an anode-facing side and the coating comprises a trap layer.

3. The battery of claim 1, wherein the trap layer has a potential difference vs. Li+/Li that is in the range of +0.0V to +5.0V.

4. The battery of claim 3, wherein the potential difference is +0.0 to +3.39 V or is +0.0 to +3.0 V.

5. The battery of claim 2, wherein the trap layer has a bulk or volume resistivity of 10⁴ to 10⁹ ohms-cm or 10⁴ to 10⁸ ohms-cm.

6. The battery of claim 5, wherein the trap layer has a bulk or volume resistivity of 10⁴ to 10⁷ ohms-cm.

7. The battery of claim 2, wherein the trap layer comprises at least carbon and a polymer.

8. The battery of claim 7, wherein carbon is a conductive carbon such as carbon nanotubes.

9. The battery of claim 7, wherein the carbon is selected from carbon black, acetylene black, carbon nanotubes, graphene, or combinations thereof.

10. The battery of claim 2, wherein the conductive coating comprise a conductive polymer.

11. The battery of claim 10, wherein the conductive polymer is selected from a poly-acetylene, a poly-thiophene, a poly-aniline, a poly-pyrrole, or combinations thereof.

12. The battery of claim 1, wherein the battery separator is a coated or uncoated battery separator and the battery separator comprises a trap layer in the middle of the battery separator or on a side of the battery separator closest to the anode.

13. The battery of claim 12, wherein the battery separator comprises a trap layer in the middle of the battery separator.

14. The battery of claim 12, wherein the battery separator comprises a trap layer on the side of the battery separator closest to the anode.

15. The battery of claim 12 to 14, wherein the battery separator is formed by a co-extrusion process, a lamination process, or combinations thereof.

16. The battery of claim 15, wherein the battery separator is formed by a coextrusion process or a combination of a coextrusion process and a lamination process.

17. The battery of claim 12, wherein the trap layer has a potential difference vs. Li+/Li that is in the range of +0.0V to +5.0V.

18. The battery of claim 17, wherein the potential difference vs. Li+/Li that is in the range of +0.0V to +3.39V.

19. The battery of claim 17, wherein the potential difference vs. Li+/Li that is in the range of +0.0V to +3.0 V.

20. The battery of claim 12, wherein the trap layer has a bulk or volume resistivity of 10⁴ to 10⁹ ohms-cm or 10⁴ to 10⁸ ohms-cm.

21. The battery of claim 20, wherein the trap layer has a bulk or volume resistivity of 10⁴ to 10⁷ ohms-cm.

22. The battery of claim 12, wherein the trap layer comprises at least carbon and a polymer.

23. The battery of claim 22, wherein carbon is a conductive carbon such as carbon nanotubes.

24. The battery of claim 22, wherein the carbon is selected from carbon black, acetylene black, carbon nanotubes, graphene, or combinations thereof.

25. The battery of claim 12, wherein the trap layer comprise a conductive polymer.

26. The battery of claim 25, wherein the conductive polymer is selected from a poly-acetylene, a poly-thiophene, a poly-aniline, a poly-pyrrole, or combinations thereof.

27. The battery of claim 1, wherein the cathode comprises Lithium Nickel Cobalt Manganese Oxide (NMC or NCM), Lithium Iron Phosphate (LFP), Lithium Nickel Manganese Spinel (LMNO), Lithium Nickel Cobalt Aluminum Oxide (NCA), Lithium Manganese Oxide (LMO), Lithium Cobalt Oxide (LCO), or combinations thereof.

28. The battery of claim 13, wherein the battery separator is formed by a co-extrusion process, a lamination process, or combinations thereof.

29. The battery of claim 14, wherein the battery separator is formed by a co-extrusion process, a lamination process, or combinations thereof.

30. The battery of claim 13, wherein the trap layer has a potential difference vs. Li+/Li that is in the range of +0.0V to +5.0V.

31. The battery of claim 14, wherein the trap layer has a potential difference vs. Li+/Li that is in the range of +0.0V to +5.0V.

32. The battery of claim 13, wherein the trap layer has a bulk or volume resistivity of 10⁴ to 10⁹ ohms-cm or 10⁴ to 10⁸ ohms-cm.

33. The battery of claim 14, wherein the trap layer has a bulk or volume resistivity of 10⁴ to 10⁹ ohms-cm or 10⁴ to 10⁸ ohms-cm.

34. The battery of claim 13, wherein the trap layer comprises at least carbon and a polymer.

35. The battery of claim 14, wherein the trap layer comprises at least carbon and a polymer.

36. The battery of claim 13, wherein the trap layer comprise a conductive polymer.

37. The battery of claim 14, wherein the trap layer comprise a conductive polymer.

38. A battery separator adapted to be placed between the anode and the cathode of a secondary battery that generates or comprises metal-ion contaminants selected from copper ions, manganese ions, nickel ions, cobalt ions, iron ions, chrome or Cr ions, molybdenum ions, tin ions or combinations thereof, the battery separator comprising:
a coated or uncoated battery separator having a trap layer on at least one side thereof or in the middle thereof, wherein the trap layer is at least one of:
a coating on an anode-facing side;
has a potential difference vs. Li+/Li that is in the range of +0.0V to +5.0V;
has a potential difference that is in the range of +0.0 to +3.39 V;
has a potential difference that is in the range of +0.0 to +3.0 V;
has a bulk or volume resistivity of 10⁴ to 10⁹ ohms-cm;
has a bulk or volume resistivity of 10⁴ to 10⁸ ohms-cm;
has a bulk or volume resistivity of 10⁴ to 10⁷ ohms-cm;
at least carbon and a polymer;
at least carbon and a polymer wherein the carbon is a conductive carbon such as carbon nanotubes;
at least carbon and a polymer wherein the carbon is selected from carbon black, acetylene black, carbon nanotubes, graphene, or combinations thereof;
a conductive coating comprising a conductive polymer;
a conductive coating comprising a conductive polymer wherein the conductive polymer is selected from a poly-acetylene, a poly-thiophene, a poly-aniline, a poly-pyrrole, or combinations thereof;
a trap layer in the middle of the battery separator or on a side of the battery separator closest to the anode;
a trap layer in the middle of the battery separator; and/or,
a trap layer on the side of the battery separator closest to the anode.

39. The battery separator of claim 38, wherein the trap layer is at least two of:
a coating on an anode-facing side;
has a potential difference vs. Li+/Li that is in the range of +0.0V to +5.0V;
has a potential difference that is in the range of +0.0 to +3.39 V;
has a potential difference that is in the range of +0.0 to +3.0 V;
has a bulk or volume resistivity of 10⁴ to 10⁹ ohms-cm;
has a bulk or volume resistivity of 10⁴ to 10⁸ ohms-cm;
has a bulk or volume resistivity of 10⁴ to 10⁷ ohms-cm;
at least carbon and a polymer;
at least carbon and a polymer wherein the carbon is a conductive carbon such as carbon nanotubes;
at least carbon and a polymer wherein the carbon is selected from carbon black, acetylene black, carbon nanotubes, graphene, or combinations thereof;
a conductive coating comprising a conductive polymer;
a conductive coating comprising a conductive polymer wherein the conductive polymer is selected from a poly-acetylene, a poly-thiophene, a poly-aniline, a poly-pyrrole, or combinations thereof;
a trap layer in the middle of the battery separator or on a side of the battery separator closest to the anode;
a trap layer in the middle of the battery separator; and/or,
a trap layer on the side of the battery separator closest to the anode.

40. The battery separator of claim 38, wherein the trap layer is at least three of:
a coating on an anode-facing side;
has a potential difference vs. Li+/Li that is in the range of +0.0V to +5.0V;
has a potential difference that is in the range of +0.0 to +3.39 V;
has a potential difference that is in the range of +0.0 to +3.0 V;
has a bulk or volume resistivity of 10⁴ to 10⁹ ohms-cm;
has a bulk or volume resistivity of 10⁴ to 10⁸ ohms-cm;
has a bulk or volume resistivity of 10⁴ to 10⁷ ohms-cm;
at least carbon and a polymer;
at least carbon and a polymer wherein the carbon is a conductive carbon such as carbon nanotubes;
at least carbon and a polymer wherein the carbon is selected from carbon black, acetylene black, carbon nanotubes, graphene, or combinations thereof;
a conductive coating comprising a conductive polymer;
a conductive coating comprising a conductive polymer wherein the conductive polymer is selected from a poly-acetylene, a poly-thiophene, a poly-aniline, a poly-pyrrole, or combinations thereof;
a trap layer in the middle of the battery separator or on a side of the battery separator closest to the anode;
a trap layer in the middle of the battery separator; and/or,
a trap layer on the side of the battery separator closest to the anode.

41. The battery separator of claim 38, wherein the battery separator is formed by a co-extrusion process, a lamination process, or combinations thereof.

42. The battery separator of claim 38, wherein the battery separator is formed by a coextrusion process or a combination of a coextrusion process and a lamination process.

43. In a secondary battery that generates or comprises metal-ion contaminants selected from copper ions, manganese ions, nickel ions, cobalt ions, iron ions, chrome or Cr ions, molybdenum ions, tin ions or combinations thereof, the improvement comprising the battery separator of claim 38.

44. In a secondary battery that generates or comprises metal-ion contaminants selected from copper ions, manganese ions, nickel ions, cobalt ions, iron ions, chrome or Cr ions, molybdenum ions, tin ions or combinations thereof, the improvement comprising the battery separator of claim 39.

45. In a secondary battery that generates or comprises metal-ion contaminants selected from copper ions, manganese ions, nickel ions, cobalt ions, iron ions, chrome or Cr ions, molybdenum ions, tin ions or combinations thereof, the improvement comprising the battery separator of claim 40.
